(19) United States
(12) Patent Application Publication
(10) Pub. No.: US 2012/0086741 A1
(43) Pub. Date: Apr. 12, 2012

(54) Image Display Device

(75) Inventor: Shinsuke Yokonuma, Osaka (JP)

(73) Assignee: SHARP KABUSHIKI KAISHA, Osaka-shi, Osaka (JP)

(21) Appl. No.: 13/378,700

(22) PCT Filed: Mar. 19, 2010
(86) PCT No.: PCT/JP10/54809

§ 371 Date: Dec. 16, 2011

(30) Foreign Application Priority Data
Jul. 1, 2009 (JP) 2009-156527

(51) Int. Cl. G09G 5/10; G09G 3/36; G09G 5/00

(52) U.S. Cl. 345/690; 345/102; 345/82

(57) ABSTRACT

The present image display device starts lighting up LEDs provided in a backlight unit (8) at the end (time t₄) of rendering the first frame of a blank image (an entirely black display image) that is displayed for the purpose of solving variations in potential among pixel electrodes upon device activation. As a result, it is ensured that the luminances of the LEDs reach 100% before time t₆ at which an input image is started to be displayed, so that changes in luminance due to the lighting up of the backlight unit are not visually recognized upon device activation and also the lighting luminance does not become insufficient at the time of image display.

### TECHNICAL FIELD

The present invention relates to image display devices and methods for controlling the same, particularly to an image display device provided with a backlight and a method for controlling the same.

### BACKGROUND ART

Image display devices provided with backlights, such as liquid crystal display devices, of ten use LED lighting devices which include LEDs (light emitting diodes) as backlight sources. LEDs are capable of blinking at high speed (e.g., several hundred kilohertz), and therefore can be lit up with predetermined luminances by driving them with, for example, PWM (pulse width modulation) signals with predetermined duty ratios.

Japanese Laid-Open Patent Publication No. 2007-241286 describes a liquid crystal display device in which a PWM signal drives an LED lighting device which is a backlight. In this conventional device, the start of lighting up LEDs (the start of the drive) is synchronized with the start of a frame. Specifically, in this configuration, backlighting starts upon change of a display image (data updating). Accordingly, it is possible to suppress any flicker phenomenon due to the difference in the frequencies of these operations.

### Citation List

### Patent Document

[Patent Document 1] Japanese Laid-Open Patent Publication No. 2007-241286

### SUMMARY OF THE INVENTION

### Problems to be Solved by the Invention

However, in the case of the conventional display device, when the lighting luminances of the LEDs are changed from 0% to 100%, a certain period of time is taken before the lighting luminances of the LEDs reach 100% from the start of a frame. Specifically, changing the LEDs from an OFF to ON state requires, for example, only about several microseconds of time, but in some cases, changing the frequency of an oscillator for generating PWM signals and thereby changing the duty ratio of the oscillator from 0% to 100% might take, for example, about several milliseconds of time. In such a case, the lighting luminance of the backlight might become insufficient for a given period of time from the start of a frame. As a result, in some cases, the luminance of the backlight as a whole might become insufficient.

Furthermore, the display screen upon device activation (including the case of the device returning from a suspended state) is black (in the case of a normally black type), and therefore, particularly in the case where the display screen is initially white, changes in the luminances of the LEDs from 0% to 100% can be susceptible to visual recognition, which might result in reduced display quality of the display device upon device activation.

Therefore, an objective of the present invention is to provide an image display device in which any change of luminance due to a backlight unit being lit up is not visually recognized upon device activation and the lighting luminance of the backlight does not become insufficient.

### Solution to the Problems

A first aspect of the present invention is directed to an image display device with a display panel for image display and a backlight, the device comprising:
a backlight driver circuit for driving the backlight by a pulse width modulation (PWM) signal;
a panel driver circuit for driving the display panel; and
a display control circuit for instructing the backlight driver circuit to start driving the backlight, externally receiving video data, providing the video data to the panel driver circuit, and controlling the panel driver circuit to display the video data, wherein,
the display control circuit provides an instruction to start driving the backlight, which is in an OFF state at a predetermined point including a point of device activation, at a predetermined point earlier than a point retroactive for a time period required for the backlight's emission luminance to be maximized from a start point of image display on the display panel.

In a second aspect of the present invention, based on the first aspect of the invention, the display panel includes a plurality of pixel formation portions arranged in a matrix, and the display control circuit provides the panel driver circuit with predetermined data, such that the same liquid crystal drive voltage is applied to each of the pixel formation portions for one or more predetermined unit cycles later than the point at which the backlight is off but before the video data is provided to the panel driver circuit, and also provides the instruction to start driving the backlight at a predetermined point at least later than an end of one unit cycle of providing the data.

In a third aspect of the present invention, based on the second aspect of the invention, the display panel further includes a common electrode for providing a common potential to the pixel formation portions, and auxiliary capacitance lines each being arranged in a row and extending in a direction of the row, and the panel driver circuit alternatingly switches potentials of the auxiliary capacitance lines between first and second potentials, such that the liquid crystal drive voltage has its polarity inverted every row of the display panel.

In a fourth aspect of the present invention, based on the second aspect of the invention, the display control circuit provides the data for two unit cycles, and also provides the instruction to start driving the backlight at a predetermined point later than an end of the first unit cycle of providing the data.

In a fifth aspect of the present invention, based on the first aspect of the invention, the backlight includes LEDs (light emitting diodes) as light sources.

A sixth aspect of the present invention is directed to a method for controlling an image display device with a display panel for image display and a backlight, the method comprising:
a backlight drive step of driving the backlight by a pulse width modulation (PWM) signal;
a panel drive step of driving the display panel; and
a display control step of providing an instruction to start driving the backlight in the backlight drive step, externally receiving video data, and performing control to use and display the video data in the panel drive step, wherein,
in the display control step, the instruction to start driving the backlight, which is in an OFF state at a predetermined point including a point of device activation, at a predetermined point earlier than a point retroactive for a time period required for the backlight's emission luminance to be maximized from a start point of image display on the display panel.

### Effects of the Invention

According to the first aspect of the present invention, the display control circuit provides an instruction to start driving the backlight, which is in an OFF state at a predetermined point including a point of device activation, at a predetermined point earlier than a point retroactive for a time period required for the backlight's emission luminance to be maximized from a start point of image display on the display panel, thereby making it possible to prevent changes in luminance due to the lighting up of the backlight unit from being visually recognized at the start of image display and also prevent the lighting luminance of the backlight from becoming insufficient at the time of image display.

According to the second aspect of the present invention, the panel driver circuit is provided with predetermined data, such that the same liquid crystal drive voltage is applied to each of the pixel formation portions for one or more predetermined unit cycles later than the point at which the backlight is off but before the video data is provided to the panel driver circuit, and also the instruction to start driving the backlight is provided at a predetermined point at least later than an end of one unit cycle of providing the data, thereby making it possible to prevent any unintended display from being visually recognized during the one or more unit cycles.

According to the third aspect of the present invention, the panel driver circuit inverts the polarity of the liquid crystal drive voltage at least every unit cycle, and therefore it is possible to realize inversion drive of the liquid crystal and also possible to prevent an unintended display from being visually recognized.

According to the fourth aspect of the present invention, the backlight is started to be driven at a predetermined point later than an end of the first unit cycle of providing the data, thereby making it possible to prevent any unintended display while preventing changes in luminance due to the lighting up of the backlight unit from being visually recognized at the start of image display, and also prevent the lighting luminance of the backlight from becoming insufficient at the time of image display.

According to the fifth aspect of the present invention, LEDs are used as light sources of the backlight, and therefore it is possible to control the lighting up by a PWM signal in a simplified and accurate manner, and also possible to reduce power consumption.

According to the sixth aspect of the present invention, it is possible for an image display device control method to achieve an effect similar to that achieved in the first aspect of the invention.

### BRIEF DESCRIPTION OF THE DRAWINGS

FIG. 1 is a block diagram illustrating the configuration of a liquid crystal display device according to an embodiment of the present invention.

FIG. 2 is a diagram of an equivalent circuit for a portion of a liquid crystal panel in the embodiment.

FIG. 3 is a diagram illustrating an example of the relationship between display image data upon device activation and the timing of lighting up a backlight in the embodiment.

FIG. 4 is a diagram describing display image data and the timing of lighting up a backlight in a conventional device.

FIG. 5 is a diagram illustrating another example of the relationship between display image data upon device activation and the timing of lighting up a backlight in the embodiment.

### MODE FOR CARRYING OUT THE INVENTION

Hereinafter, an embodiment of the present invention will be described with reference to the accompanying drawings.

<1. Overall Configuration and Outline of the Operation>

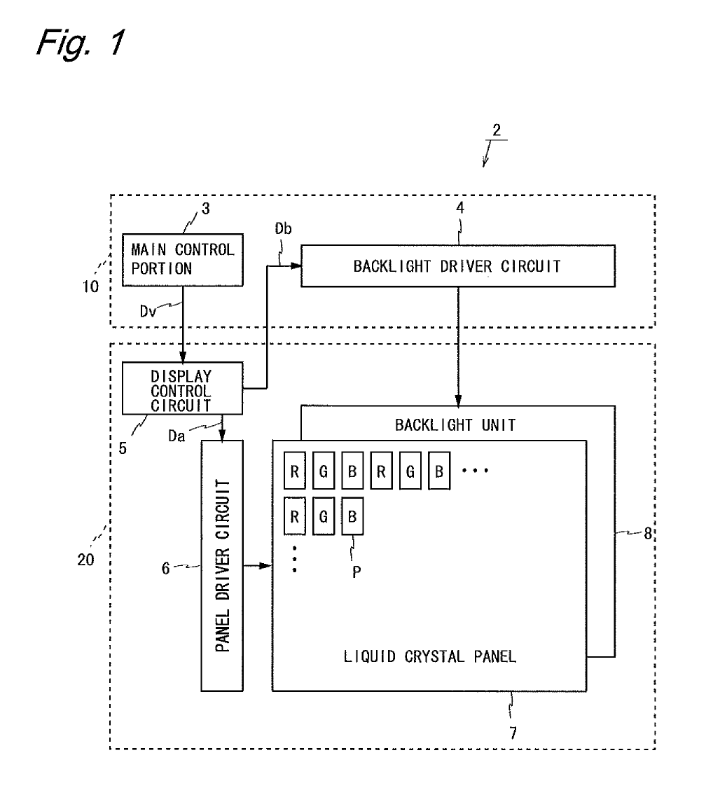

FIG. 1 is a block diagram illustrating the configuration of a liquid crystal display device 2 according to an embodiment of the present invention. The liquid crystal display device 2 shown in FIG. 1 is, for example, a television receiver which includes a main board 10 and a display board 20 and receives airwaves thereby to acquire input images Dᵥ, which are made of color image data indicating luminances of (m×n) pixels for each of the colors R, G, and B.

The main board 10 includes a main control portion 3 and a backlight driver circuit 4, and the displayboard 20 includes a display control circuit 5, a panel driver circuit 6, a liquid crystal panel 7, and a backlight unit 8.

The main control portion 3 provides the display control circuit 5 with the input images Dᵥ acquired as above. On the basis of the received input images Dᵥ, the display control circuit 5 obtains display data (hereinafter, referred to as “liquid crystal data Dₐ”) for use in driving the liquid crystal panel 7, and then outputs a PWM drive start signal D_{b} at an appropriate time to provide an instruction to start driving the backlight unit 8 (details will be described later).

The liquid crystal panel 7 is a liquid crystal panel of a so-called normally black type which displays black when no voltage is applied to the liquid crystal, and includes (m×n×3) display elements P. The display elements P are two-dimensionally arranged as a whole with 3 m of them in the direction of each row (horizontally in FIG. 1) and n of them in the direction of each column (vertically in FIG. 1). The display elements P include R display elements having color filters for transmitting red light therethrough, G display elements having color filters for transmitting green light therethrough, and B display elements having color filters for transmitting blue light therethrough. Each set of three display elements, i.e., the R, G, and B display elements, arranged in the row direction forms one pixel. Note that the structures of these color filters and the method for forming them are well-known, and therefore any descriptions thereof will be omitted herein.

Here, concretely, the liquid crystal panel 7 includes a plurality of video signal lines and a plurality of scanning signal lines, and the video signal lines and the scanning signal lines are arranged in lattice formation, such that each of the video signal lines crosses each of the scanning signal lines. In addition, a plurality of pixel formation portions are provided at the intersections of the video signal lines and the scanning signal lines.

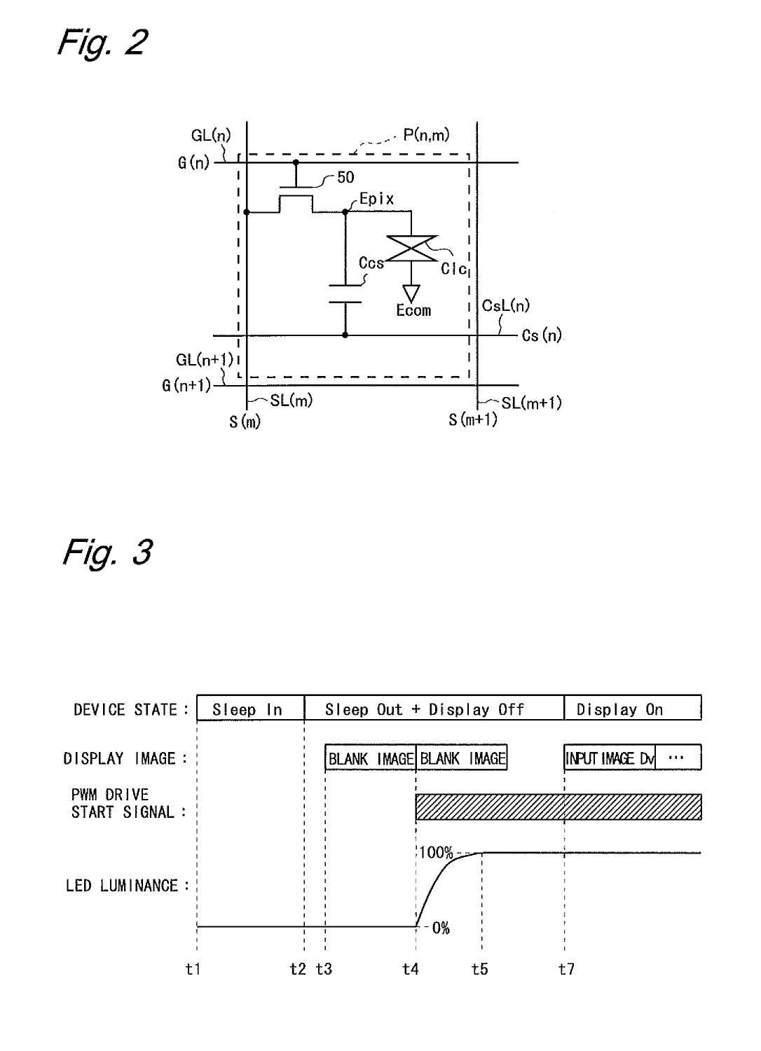

FIG. 2 illustrates an equivalent circuit for one pixel formation portion in a part of the liquid crystal panel 7 of the present embodiment. As shown in FIG. 2, each pixel formation portion P(n, m) is made up of: a TFT 50, which is a switching element having a gate terminal connected to a scanning signal line GL (n) or a scanning signal line GL (n+1) adjacent thereto and a source terminal connected to a video signal line SL(m) passing through the intersection or a video signal line SL (m+1) adjacent thereto; a pixel electrode Eₚᵢₓ connected to a drain terminal of the TFT 50; a common electrode E_{com} commonly provided for the pixel formation portions P (i, j), where i=1 to N, and j=1 to M; and a liquid crystal layer, which is an electro-optic element commonly provided for the pixel formation portions P (i, j) , where i=1 to N, and j=1 to M, and sandwiched between the pixel electrode Eₚᵢₓ and the common electrode E_{com}.

The pixel formation portions P(n, m) have liquid crystal capacitances (also referred to as “pixel capacitances”) C_{1c} formed by the pixel electrodes Eₚᵢₓ and the common electrode E_{com} being opposed thereto with respect to the liquid crystal layer. Each of the pixel electrodes Eₚᵢₓ has two video signal lines SL (m) and SL (m+1) provided so as to sandwich that pixel electrode therebetween, and is connected to the video signal line SL(m) via the TFT 50.

Furthermore, each scanning signal line GL (n) has an auxiliary capacitance line CₛL (n) formed in parallel therewith, and each pixel formation portion P(n,m) has an auxiliary capacitance C_{cs} between the pixel electrode Eₚᵢₓ and the auxiliary capacitance line CₛL (n). Accordingly, the potential of the pixel electrode Eₚᵢₓ changes relative to the common electrode E_{com} in response to a change in the potential of the auxiliary capacitance line CₛL (n), in accordance with the proportion of the auxiliary capacitance in the sum of the liquid crystal capacitance value C_{1c} and the auxiliary capacitance value C_{cs}.

Here, liquid crystal layers are known to deteriorate when being driven by direct current, and therefore inversion drive is performed for the purpose of suppressing deterioration of the liquid crystal and maintaining the quality of display. Specifically, employed here is a drive system (referred to as a “line-inversion drive system”) in which the polarity of the voltage being applied to the pixel liquid crystal is inverted every horizontal scanning line and also every frame. Note that a drive system (referred to as a “frame-inversion drive system”) in which the inversion occurs only every frame may be employed, or another well-known drive system may be employed. In addition, the frame rate frequency in general is 60 Hz, and the present liquid crystal display device is assumed to provide display at a similar frequency to normal.

The panel driver circuit 6 is a circuit for driving the liquid crystal panel 7. On the basis of liquid crystal data Dₐ outputted by the display control circuit 5, the panel driver circuit 6 outputs video signals (voltage signals) for controlling the light transmittance of the display elements P to the liquid crystal panel 7 via corresponding video signal lines. The voltages outputted by the panel driver circuit 6 are written to pixel electrodes (not shown) in the display elements P, so that the light transmittance of the display elements P changes in accordance with the voltages written on the pixel electrodes. In addition, to realize the line-inversion drive, the panel driver circuit 6 drives corresponding auxiliary capacitance lines such that inversion occurs every horizontal scanning line with the voltage applied to the common electrode being fixed at a predetermined potential.

The backlight unit 8 is provided on the back surface side of the liquid crystal panel 7, and irradiates the back surface of the liquid crystal panel 7 with backlight. For example, the backlight unit 8 may be a backlight unit of a so-called tandem type provided with an LED unit, which functions as a white light source, and a light guide plate, an optical sheet, or the like, to guide the white light to the liquid crystal panel 7, or may be a backlight unit of a direct type having a number of LED units arranged directly below the liquid crystal panel 7. Note that one or more types of LEDs used in the backlight may be combined with another light-emitting device, a fluorescent substance, or the like. By using LEDs as light sources in the above manner, it is rendered possible to control their lighting in a simplified and accurate manner.

The backlight driver circuit 4 is a circuit for driving the backlight unit 8. On the basis of a PWM drive start signal D_{b} outputted by the display control circuit 5, the backlight driver circuit 4 outputs PWM drive signals for controlling the luminances of the LEDs to the backlight unit 8. Note that the luminances of the LEDs are determined by the duty ratios of the PWM signals, and any description of the luminance control will be omitted assuming that the luminance control is appropriately performed, for example, in accordance with the user's instruction.

In this manner, in the case of the liquid crystal display device 2, the luminance of each R display element is the product of the luminance of light emitted from the backlight unit 8 and the light transmittance of the R display element. This can be similarly said of the luminances of the G and B display elements. Thus, the liquid crystal display device 2 controls the light transmittance of the display elements P on the basis of the liquid crystal data Dₐ obtained from the input images Dᵥ, so that the input images Dᵥ can be displayed on the liquid crystal panel 7.

Here, in some cases, the inversion drive might result in abnormal display when a normal display operation is performed upon activation of the liquid crystal display device 2 (including the case of the device returning from a suspended state). Therefore, the liquid crystal display device 2 performs a special operation upon device activation. Hereinafter, referring to FIG. 3, the operation upon activation will be described along with the timing of lighting up the backlight unit.

<2. Operation Upon Device Activation>

FIG. 3 is a diagram describing display image data upon device activation and the timing of lighting up the backlight in the present embodiment. Here, the point of device activation will be described taking as an example the point of the device returning from a suspended state (referred to as a “sleep state”).

At time t₁ shown in FIG. 3, when it is not necessary to, for example, power on the device, reset hardware, or operate the device, the device is in a sleep state. At this time, the device is in such a state as to have a “sleep-in” command issued thereto (hereinafter, this state is simply referred to as “sleep-in”), and the LEDs are not driven by PWM signals, and therefore not lit up.

Next, at time t₂, when, for example, the user makes an input, the device returns from the sleep state. At this time, the device (simply) enters in a “sleep out” state, specifically, in a “display off” state to perform a process to be described later.

Subsequently, at time t₃ after a lapse of a predetermined time period from time t₂, the display control circuit 5 starts an operation of providing a blank image (an image to be displayed entirely in black) for two frames to the panel driver circuit 6 as liquid crystal data Dₐ . This operation is performed for the purpose of uniformly keeping the potentials of pixel electrodes at a level corresponding to a black display because variations might have occurred among the potentials during the sleep state.

Concretely, the display control circuit 5 consistently applies a predetermined ground potential to the common electrode, applies a voltage that corresponds to the black display to corresponding video signal lines, and starts driving the auxiliary capacitance lines. At this time, the voltage to be applied to the liquid crystal is determined on the basis of an application voltage where the potentials of the pixel electrodes are floating, but at time t₃ when the liquid crystal panel 7 starts to be driven, the potentials of all auxiliary capacitance lines are set at the ground potential. Accordingly, when positive potentials are applied to the auxiliary capacitance lines, the voltage that corresponds to the black display can be provided to the pixel electrodes, but when negative potentials are applied to the auxiliary capacitance lines, the potentials of the auxiliary capacitance lines do not change, so that an appropriate voltage cannot be applied to the liquid crystal, resulting in a voltage more than the voltage that corresponds to the black display being applied to and held in the pixel electrodes (here, for convenience of description, the voltage being assumed to correspond to a white display). As a result, from time t₃ to time t₄, rows having positive potentials applied thereto are displayed in black, and rows having negative potentials applied thereto are displayed in white, resulting in a display image P different from the black display (hereinafter, such a display will be also referred to as a white display, but in actuality, the display as a whole is gray). At this point, however, no PWM drive start signal has been provided yet, as shown in FIG. 3, and no LEDs have been driven yet, so that their luminances are 0%. Thus, it is possible to inhibit an unintended white display (gray display) image from being presented.

Next, at time t₄, the display control circuit 5 starts an operation of providing the second frame of the blank image. At this time, the display control circuit 5 consistently applies a predetermined ground potential to the common electrode and the voltage that corresponds to the black display to corresponding video signal lines, and also drives auxiliary capacitance lines. In this case, by the driving of the first frame, each of the auxiliary capacitance lines has either a positive or negative potential normally applied thereto, so that the voltage that corresponds to the black display is correctly applied and held in each pixel electrode. Accordingly, at this time, even if the backlight is lit up, a black display image is displayed, so that an unintended white display (gray display) image is not displayed. Therefore, at time t₄, the display control circuit 5 outputs a PWM drive start signal D_{b} to the backlight driver circuit 4. Upon reception of the PWM drive start signal D_{b}, the backlight driver circuit 4 starts an operation of changing the duty ratios of PWM signals from 0% to 100%. Note that about several milliseconds of time is taken to complete this operation, and therefore the luminances of the LEDs reach 100% at time t₅ after a lapse of a time period required for completing the operation since time t₄.

Thereafter, at time t₇, the device starts displaying input images Dᵥ. The state of the device at this time is “Display On” , and the LEDs are lit up with their 100% luminances, causing no problem with the displaying.

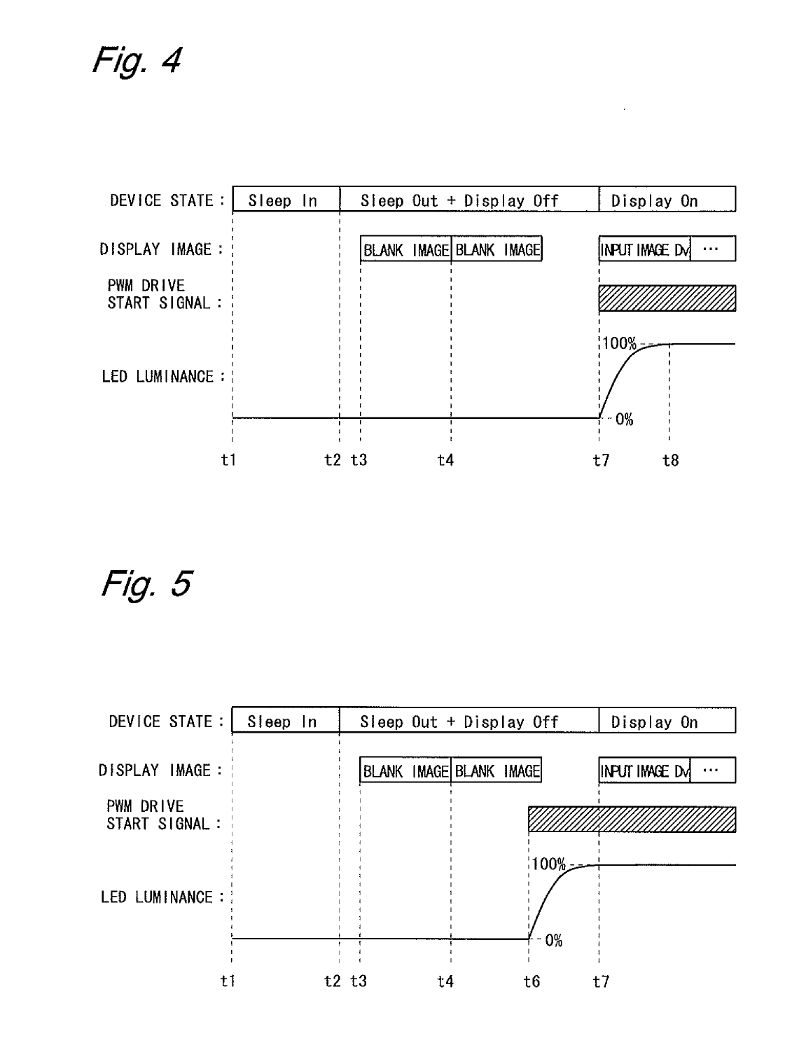

On the other hand, in the case of the conventional display device described in the aforementioned publication, the start of lighting up the LEDs (the start of the drive) is in synchronization with the start of a frame, and therefore the LEDs start lighting up at time t₇, as shown in FIG. 4. As a result, since the luminances of the LEDs are 0% at that time, sufficient luminances required for displaying the images are not obtained until time t₇ at which the luminances of the LEDs reach 100%. In addition, particularly when the initial display screen (input image Dᵥ) is a white display, the changes in the luminances of the LEDs from 0% to 100% are susceptible to visual recognition, resulting in reduced quality of display by the display device upon device activation.

Accordingly, with characteristics of a PWM signal generation circuit in the backlight driver circuit 4 taken into consideration along with a piece-to-piece variation, to ensure that the LEDs are lit up with their 100% luminances at the point of displaying the initial display screen (time t₇ shown in FIGS. 3 and 4), the driving of the LEDs is preferably started at the earliest possible time, i.e., at the end of rendering the first frame of the blank image (or at the start of rendering the second frame).

However, shortening the time of lighting up the backlight as much as possible can save power consumption, and furthermore, to ensure that a white display (gray display) is prevented at the point of displaying a blank image, it is preferable to start driving the LEDs at a later time. Therefore, when these points are considered, it is preferable to set time t₆ (which is a point earlier than time t₇ by a period from time t₄ to time t₅ shown in FIG. 3) as the latest time of starting the driving of the LEDs, such that the point at which the luminances of the LEDs reach 100% coincides with time t₇ at which the initial display screen is displayed, as shown in FIG. 5.

<3. Effect>

As described above, the display control circuit 5 in the present embodiment starts lighting up (the LEDs provided in) the backlight unit 8 sometime between the end of rendering the first frame of the blank image (time t₄) and the point (time t₆) that is determined such that the point at which the luminances of the LEDs reach 100% coincides with the point at which the initial display screen is displayed, so that changes in luminance due to the lighting up of the backlight unit can be prevented from being visually recognized upon device activation and also the lighting luminance of the backlight can be prevented from becoming insufficient at the time of image display.

<4. Variant>

In the above embodiment, the blank image is rendered for two frames upon device activation, and such a configuration is preferred in that the voltages being applied to all pixels can be reversed in polarity once, but the blank image may be rendered only for one frame. Alternatively, the blank image may be rendered for three or more frames. In such a configuration, to prevent an unintended white display (gray display) from being provided by lighting up the backlight unit, it is preferable to start driving the LEDs at least at or after the end of the initial frame of the blank image to be rendered.

Furthermore, in the case where there are variations in potential among pixel electrodes upon device activation, the blank image may be any image that can keep their potentials uniform, e.g., an image with a different tone from the black display.

Furthermore, even in the case of a display device in which the common electrode is driven (i.e., the potential of the common electrode is not fixed), to solve variations in potential among pixel electrodes that are caused upon device activation, the blank image may be displayed. In this configuration also, by starting the lighting up of (the LEDs provided in) the backlight unit 8 at a similar point (between time t₄ to time t₆) to the above embodiment, it becomes possible to prevent changes in luminance due to the lighting up of the backlight unit from being visually recognized upon device activation and also prevent the lighting luminance of the backlight from becoming insufficient at the time of image display.

In the embodiment, LEDs are used as light sources of the backlight unit 8, but any light sources other than LEDs can be used. In such a case, it is preferable that the light sources require a predetermined period of time to transition to lighting up with their 100% luminances after an instruction to start the lighting up, and the lighting up of the backlight unit 8 be started sometime between the end of rendering the first frame of the blank image and the point that is determined such that the point at which the luminances of the light sources reach 100% coincides with the point at which the initial display screen is displayed. As a result, changes in luminance due to the lighting up of the backlight unit can be prevented from being visually recognized upon device activation and also the lighting luminance of the backlight can be prevented from becoming insufficient at the time of image display.

While the above embodiment has been described taking as an example the configuration in which the liquid crystal panel is used, any display panel which requires a backlight may be used so long as the display panel includes well-known shutter elements other than liquid crystal elements, which are controlled in terms of the transmittance for light from the backlight.

### INDUSTRIAL APPLICABILITY

The present invention can be applied to image display devices such as liquid crystal display devices, and is suitable for image display devices provided with backlights.

### Description of the Reference Characters

2 liquid crystal display device
3 main control portion
4 backlight driver circuit
5 display control circuit
6 panel driver circuit
7 liquid crystal panel
8 backlight unit
10 main board
20 liquid crystal board
50 TFT (thin-film transistor)
Eₚᵢₓ pixel electrode
E_{com} common electrode (opposing electrode)
GL(n) scanning signal line (n=1, 2, 3, . . . )
CₛL(n) auxiliary capacitance line (n=1, 2, 3, . . . )
SL(m) video signal line (m=1, 2, 3, . . . )
Dᵥ input image
Dₐ liquid crystal data
D_{b} PWM drive start signal

1. An image display device with a display panel for image display and a backlight, the device comprising:
a backlight driver circuit for driving the backlight by a pulse width modulation (PWM) signal;
a panel driver circuit for driving the display panel; and
a display control circuit for instructing the backlight driver circuit to start driving the backlight, externally receiving video data, providing the video data to the panel driver circuit, and controlling the panel driver circuit to display the video data, wherein,
the display control circuit provides an instruction to start driving the backlight, which is in an OFF state at a predetermined point including a point of device activation, at a predetermined point earlier than a point retroactive for a time period required for the backlight's emission luminance to be maximized from a start point of image display on the display panel.

2. The image display device according to claim 1, wherein,
the display panel includes a plurality of pixel formation portions arranged in a matrix, and
the display control circuit provides the panel driver circuit with predetermined data, such that the same liquid crystal drive voltage is applied to each of the pixel formation portions for one or more predetermined unit cycles later than the point at which the backlight is off but before the video data is provided to the panel driver circuit, and also provides the instruction to start driving the backlight at a predetermined point at least later than an end of one unit cycle of providing the data.

3. The image display device according to claim 2, wherein,
the display panel further includes a common electrode for providing a common potential to the pixel formation portions, and auxiliary capacitance lines each being arranged in a row and extending in a direction of the row, and
the panel driver circuit alternatingly switches potentials of the auxiliary capacitance lines between first and second potentials, such that the liquid crystal drive voltage has its polarity inverted every row of the display panel.

4. The image display device according to claim 2, wherein the display control circuit provides the data for two unit cycles, and also provides the instruction to start driving the backlight at a predetermined point later than an end of the first unit cycle of providing the data.

5. The image display device according to claim 1, wherein the backlight includes LEDs (light emitting diodes) as light sources.

6. A method for controlling an image display device with a display panel for image display and a backlight, the method comprising:
a backlight drive step of driving the backlight by a pulse width modulation (PWM) signal;
a panel drive step of driving the display panel; and
a display control step of providing an instruction to start driving the backlight in the backlight drive step, externally receiving video data, and performing control to use and display the video data in the panel drive step, wherein,
in the display control step, the instruction to start driving the backlight, which is in an OFF state at a predetermined point including a point of device activation, at a predetermined point earlier than a point retroactive for a time period required for the backlight's emission luminance to be maximized from a start point of image display on the display panel.
